(19) United States
(12) Patent Application Publication
(10) Pub. No.: US 2022/0333589 A1
(43) Pub. Date: Oct. 20, 2022

(54) AIR COMPRESSOR

(71) Applicants: Wen-San CHOU, Tainan City (TW); Cheng-Hsien CHOU, Tainan City (TW)

(72) Inventors: Wen-San CHOU, Tainan City (TW); Cheng-Hsien CHOU, Tainan City (TW)

(21) Appl. No.: 17/708,994

(22) Filed: Mar. 30, 2022

(30) Foreign Application Priority Data
Apr. 16, 2021 (TW) 110113843

(51) Int. Cl. F04B 39/00; F04B 37/10

(52) U.S. Cl. CPC F04B 39/0022; F04B 37/10

(57) ABSTRACT

An air compressor contains a piston which is actuated by a motor to move upward and downward in a cylinder. The piston includes an air stop sheet mounted on a head thereof, and the air stop sheet has a bending section, a positioning zone, and an acting zone. A piston rod extends downward from the head and includes a cavity, an air conduit, a column extending from a bottom thereof, and a spring fitted on the column and inserting through the air channel of the head along the cavity of the piston rod so that the spring abuts against a back surface of an acting zone of an air stop sheet, the air stop sheet is forced by the spring to locate in the acting zone at an open angle θ, and the air conduit and the air channel communicate with atmosphere.

### FIELD OF THE INVENTION

The present invention relates to an air compressor, and more particularly to the air compressor which includes a piston moving upward and downward in a cylinder of the air compressor.

### BACKGROUND OF THE INVENTION

A conventional air compressor contains: a motor, a piston driven by the motor to move reciprocately in a cylinder, such that airs are compressed to produce compressed airs, and the compressed airs are delivered to a storage holder from the cylinder, thereafter the compressed airs are inflated into a deflated object via an output tube of the storage holder via a delivery hose connected with the output tube. The piston includes a conduit communicating with a head thereof, an air stop sheet covered on the conduit of a plane of a top of the piston. When the air compressor stops, the air stop sheet closes the conduit of the head of the piston. After the air compressor operates again, airtightness produces among an airtight ring and the air stop sheet of the head of the piston and the air stop sheet, so the compressed airs cannot be discharged out of the cylinder completely. After starting the air compressor once more, the piston hit the compressed airs in the cylinder to increase loading and electric currents of the air compressor, thus reducing a service life of the air compressor.

The present invention has arisen to mitigate and/or obviate the afore-described disadvantages.

### SUMMARY OF THE INVENTION

The primary aspect of the present invention is to provide an air compressor by which a piston of the air compressor moves in a cylinder smoothly to enhance using safety and service life and to inflate airs into a deflated object easily.

To obtain above-mentioned aspect, an air compressor provided by the present invention contains: a piston which includes an air stop sheet mounted on a head of the piston. The air stop sheet has a bending section, the bending section has a positioning zone arranged on the head, and the bending section further has an acting zone located opposite to the positioning zone and configured to cover an air channel of the piston.

The bending section is a boundary axis of the acting area and the positioning zone of the air stop sheet so that a top of the air stop sheet facing the cylinder forms an obtuse angle less than 180 degrees, and a back surface of the acting zone of the air stop sheet backing a top of the cylinder turns on relative to a plane of a top of the head at an open angle θ, thus producing an air flowing space.

A piston rod extends downward from the head, and the piston rod includes a cavity horizontally passing through a top of the piston rod. The cavity has a column extending from a bottom thereof, and a spring fitted on the column and inserting through the air channel of the head along the cavity of the piston rod so that the spring abuts against a back surface of an air stop sheet, the air stop sheet is forced by the spring to locate at the open angle. The air conduit and the air channel communicate with atmosphere smoothly so that a pressure of the cylinder balances with the atmosphere. The piston is not stopped by an additional resistance (i.e. a back-pressure resistance) in the upward moving stroke after the air compressor is opened again, and the piston moves in the cylinder smoothly to enhance using safety and service life and to inflate the compressed airs into the deflated object easily.

The head has the two separated bolts, and the positioning zone of the air stop sheet has two spaced orifices connecting with the two separated bolts of the head. The acting zone of the air stop sheet has a passing orifice, and the head has a hook configured to engage with the passing orifice. A length (or a height) of the hook is determined based on the output power of the air compressor to match with a moving path of the air stop sheet. When the piston moves in the upward moving stroke, the air stop sheet closes the air channel. When the piston moves in the downward moving stroke, the air stop sheet is pushed by external airs to expand but is limited by the hook, thus avoiding the using fatigue of the air stop sheet. When the piston stops, the open angle produces between the acting zone of the air stop sheet and the plane of the top of the head, and the passing orifice of the air stop sheet is stopped by the hook.

The bending section includes a first collapsible guide line and a second collapsible guide line formed thereon, when the air compressor stops, the acting zone of the air stop sheet turns on relative to the plane of the top of the top support plate, and a passing orifice of the air stop sheet is stopped by of the hook.

The piston of the air compressor includes the head and a piston rod extending downward from the head, and the piston rod includes the cavity horizontally passing through a top of the piston rod and communicating with the air channel of the head, an air conduit formed in the cavity. The cavity communicates with the air channel of the head, the cavity has a column extending from a bottom thereof, and a spring fitted on the column and inserting through the air channel of the head along the cavity of the piston rod.

### BRIEF DESCRIPTION OF THE DRAWINGS

FIG. 1 is a perspective view showing the exploded components of a piston of an air compressor according to a first embodiment of the present invention.

FIG. 2 is a perspective view showing the assembly of the piston of the air compressor according to the first embodiment of the present invention.

FIG. 3 is an amplified cross sectional view showing the operation of the piston of the air compressor according to the first embodiment of the present invention.

FIG. 4 is another amplified cross sectional view showing the operation of the piston of the air compressor according to the first embodiment of the present invention.

FIG. 5 is also another amplified cross sectional view showing the operation of the piston of the air compressor according to the first embodiment of the present invention.

FIG. 6 is a cross sectional view showing the operation of the piston of the air compressor according to the first embodiment of the present invention.

FIG. 7 is another cross sectional view showing the operation of the piston of the air compressor according to the first embodiment of the present invention.

FIG. 8 is a perspective view showing the exploded components of an air compressor according to the first embodiment of the present invention.

FIG. 9 is a perspective view showing the exploded components of a piston of an air compressor according to a second embodiment of the present invention.

FIG. 10 is a cross sectional view showing the assembly of the piston of the air compressor according to the second embodiment of the present invention.

FIG. 11 is an amplified cross sectional view showing the assembly of a part of the piston of the air compressor according to the second embodiment of the present invention.

### DETAILED DESCRIPTION OF THE PREFERRED EMBODIMENTS

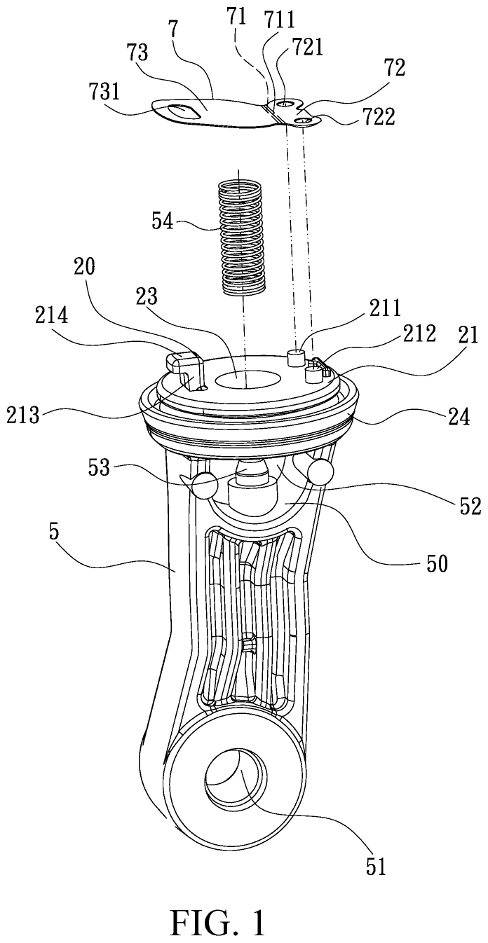

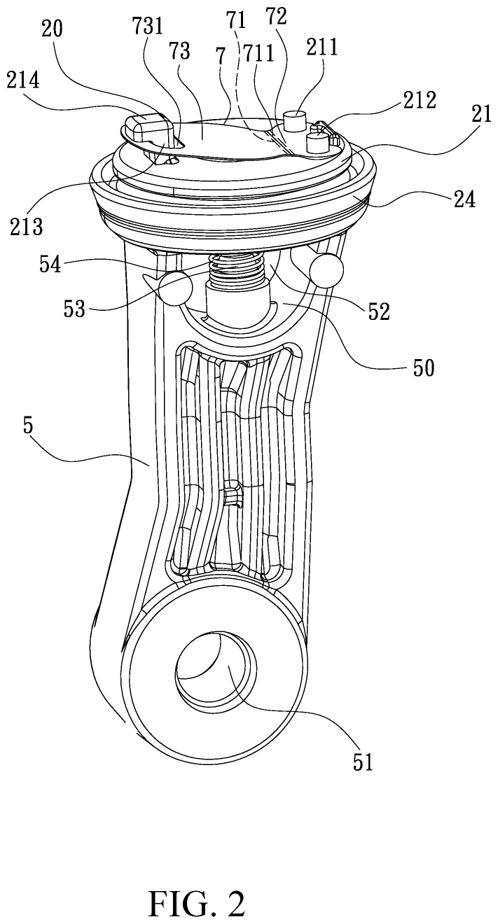

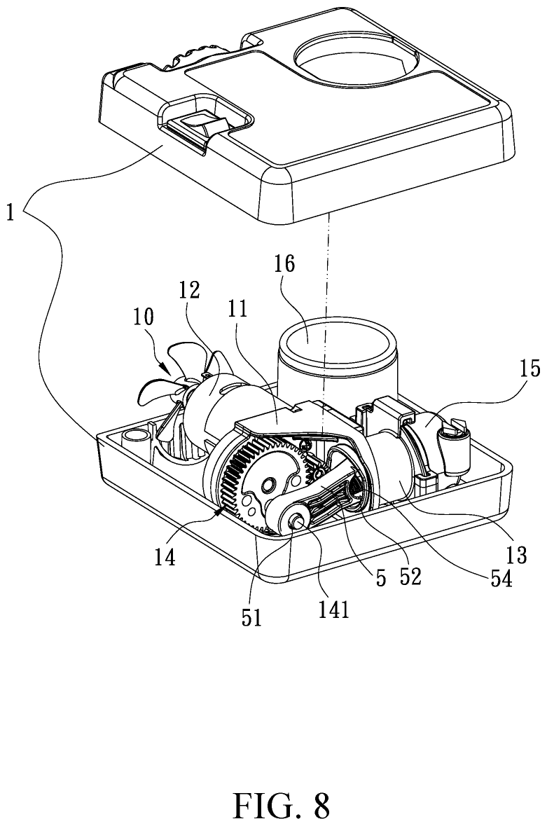

With reference to FIG. 8, an air compressor 10 according to a first embodiment of the present invention is received in an accommodation chamber, a box 1 or other a work place. In this embodiment, as shown in FIG. 8, the box 1 receives the air compressor 10 configured to inflate airs or to connect with a sealant supply (not shown), thus inflating the airs and supplying sealant. The air compressor 10 includes a substrate 11 configured to fix a motor 12, a cylinder 13 connected on the substrate 11, a transmission mechanism 14 mounted on the substrate 11 and connected with a piston. Referring to FIGS. 1 to 7, the piston includes a head 21, a seal ring 24 mounted around an outer wall of the head 21 and configured to close the piston and the cylinder 13 when the air compressor operates, and an air channel 23 communicating with the head 21, wherein a piston rod 5 extends downward from the head 21, and the piston rod 5 includes a circular orifice 51 defined on a bottom thereof and rotatably connected with a crankshaft 141 of the transmission mechanism 14, a cavity 50 horizontally passing through a top of the piston rod 5 and communicating with the air channel 23 of the head 21, an air conduit 52 formed in the cavity 50, a column 53 extending from a bottom of the cavity 50, and a spring 54 fitted on the column 50 and inserting through the air channel 23 of the head 21 along the cavity 50 of the piston rod 5 so that the spring 54 abuts against a back surface of an acting zone 73 of an air stop sheet 7, wherein the air stop sheet 7 is forced by the spring 54 to locate in the acting zone 73 at an open angle θ, and the air conduit 52 and the air channel 23 communicate with atmosphere.

When an output shaft of the motor 12 actuates the crankshaft 141 of the transmission mechanism 14 to rotate and the piston to move upward and downward in the cylinder 13, the airs are compressed to produce compressed airs, and the compressed airs flow into a storage holder 15 so as to be supplied into a pressure gauge 16 via a delivery pipe, thus displaying a pressure value. Thereafter, the compressed airs are inflated into a deflated object (not shown) via an air hose. Alternatively, the compressed airs and sealant are supplied to a broken tire (not shown) via the air hose or a valve. Since it is well-known art, further remarks are omitted.

The head 21 of the piston of the air compressor 10 accommodates the air stop sheet 7, and the air stop sheet 7 includes a bending section 71, and the bending section 71 of the air stop sheet 7 has at least one collapsible guide line 711, wherein multiple collapsible guide lines 711 are formed on the bending section 71 to match with an output power of the air compressor, wherein the air stop sheet 7 is bent at a bending angle to produce the at least one collapsible guide line 711 so that when an external pressure forces the air stop sheet 7, the air stop sheet 7 is turned on/off along the at least one collapsible guide line (or track) 711, and the at least one collapsible guide line 711 has a positioning zone 72 arranged on a plane of a top of the head 21, wherein the head 21 has the two separated bolts, and the positioning zone 72 of the air stop sheet 7 has two spaced orifices 721, 722 connecting with the two separated bolts of the head 21. The at least one collapsible guide line 711 of the air stop sheet 7 has an acting zone 73 opposite to the positioning zone 72 of the air stop sheet 7, wherein the acting zone 73 covers the air channel 23 of the piston, and the at least one collapsible guide line 711 is a boundary line of the acting area 73 and the positioning zone 72 of the air stop sheet 7 so that a positive surface of the air stop sheet 7 (i.e. a top of the air stop sheet 7 facing the cylinder 13 in an upward moving stroke) forms an obtuse angle less than 180 degrees, and a back surface of the acting zone 73 of the air stop sheet 7 backing the top of the cylinder 13 turns on relative to a plane of a top of the head 21 at the open angle θ, thus producing an air flowing space Z. Thereby, when the piston of the air compressor 10 stops, the acting zone 73 of the air stop sheet 7 turns on relative to the air channel 23 and the conduit 52, and the spring 54 of the cavity 50 of the piston rod 5 also abuts against the back surface of the acting zone 73 of the air stop sheet 7, the air flowing space Z between the air stop sheet 7 and the plane of the top of the head 21 opens, hence the air stop sheet 7 opens and closes smoothly to avoid a using fatigue, and the air channel 23 of the piston is communicated smoothly so that a pressure of the cylinder 13 balances with atmosphere. The piston is not stopped by an additional resistance (i.e. a back-pressure resistance) in the upward moving stroke after the air compressor 10 is opened again, and the piston moves in the cylinder 13 smoothly to enhance using safety and service life and to inflate the compressed airs into the deflated object easily.

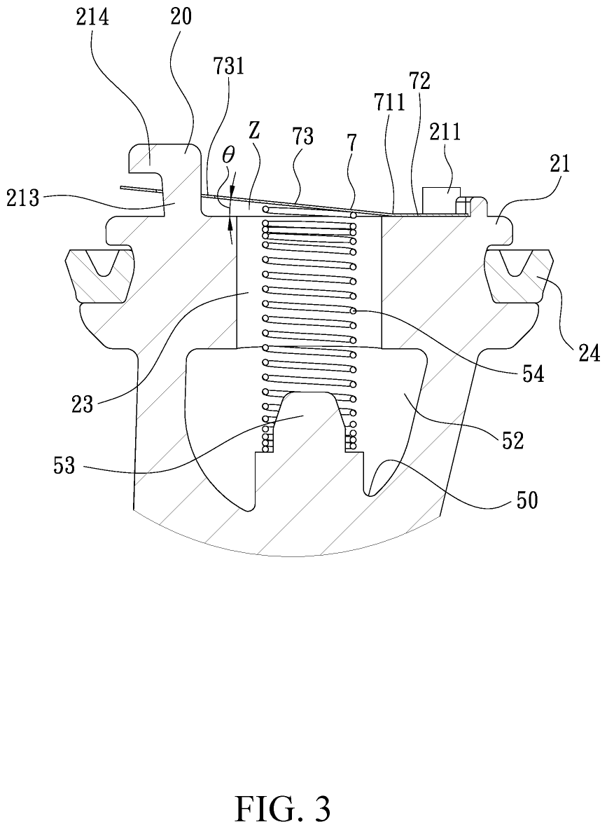

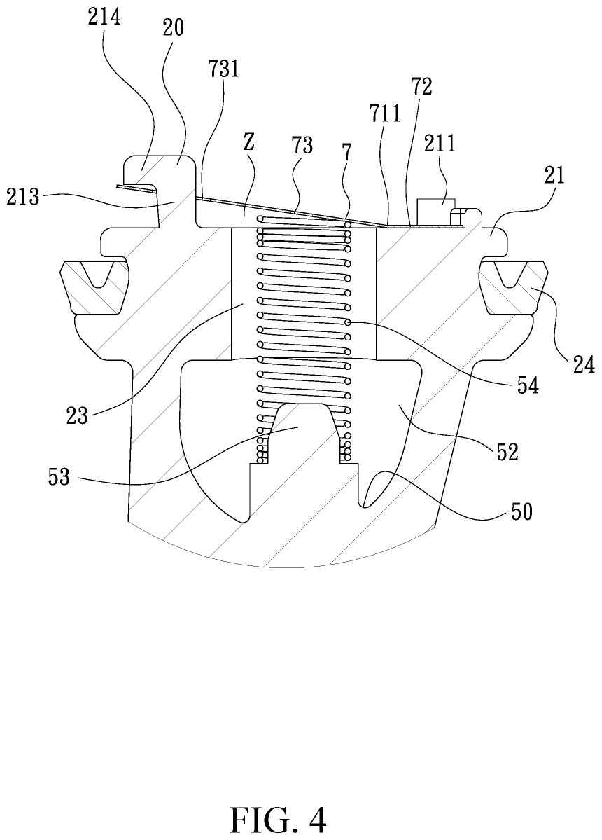

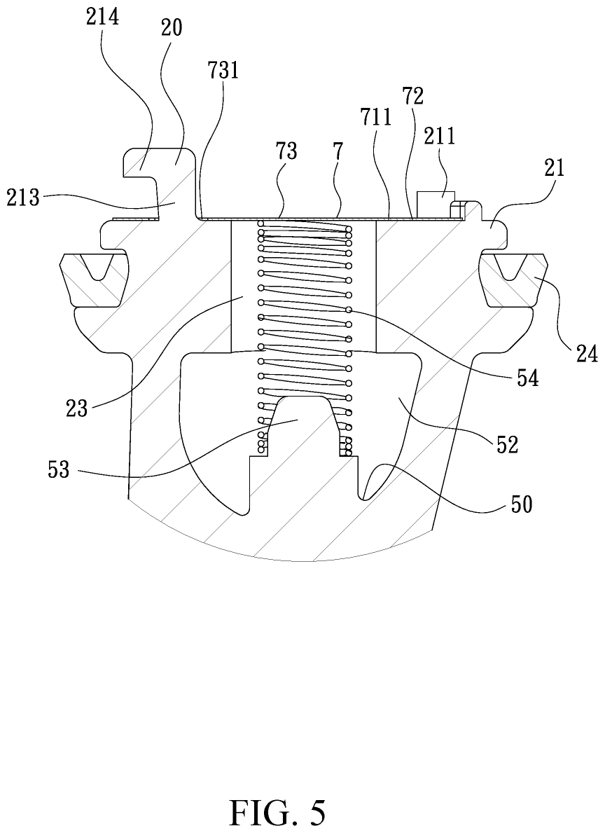

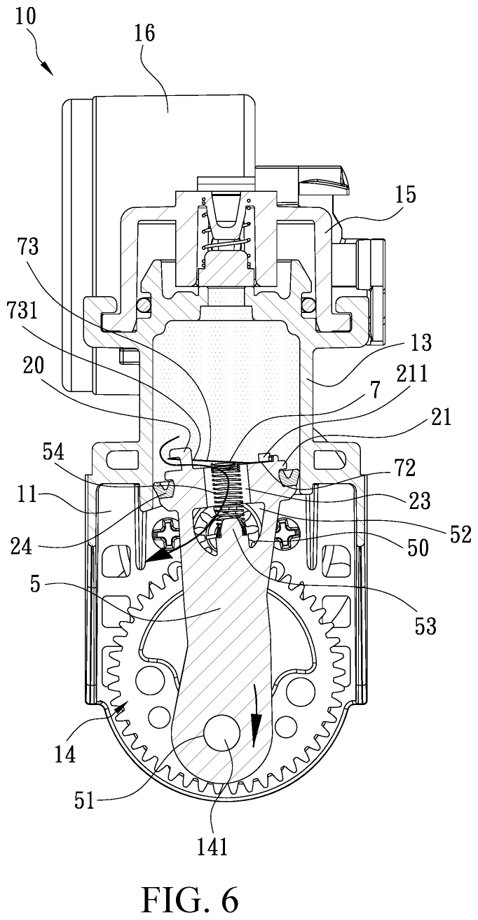

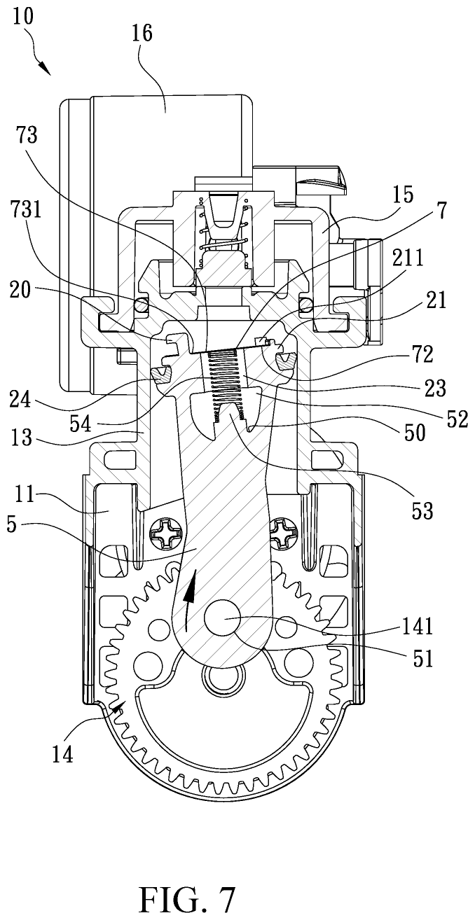

Referring to FIGS. 3-7, the piston moves in the upward moving stroke and a downward moving stroke. When the piston moves in the upward moving stroke, as illustrated in FIGS. 5 and 7, the spring 54 is pressed and the air stop sheet 7 closes the air channel 23. When the piston moves in the downward moving stroke, the spring 54 urges the air stop sheet 7 to move away from the air channel 23, and the air channel 23 opens as shown in FIGS. 4 and 6. When the piston stops, the spring 54 urges the air stop sheet 7 to expand, and the acting zone 73 of the air stop sheet 7 opens at the open angle θ by using the at least one collapsible guide line 711, as shown in FIG. 3, hence residual high-pressure airs in the cylinder 13 is balanced with atmospheric pressure via the air flowing space Z and the air channel 23, and the piston overcomes the back pressure of the air stop sheet 7 when operating again. The acting zone 73 of the air stop sheet 7 has a passing orifice 731, and the head 21 has a hook 20 configured to engage with the passing orifice 731, wherein the hook 20 has a vertical post 213 and a horizontal post 214, when the piston moves in the upward moving stroke, the acting zone 73 of the air stop sheet 7 contacts with the plane of the top of the head 21 so that the air stop sheet 7 closes the air channel 23; when the piston moves in the downward moving stroke, the air stop sheet 7 is pushed by external airs to expand but is limited by the horizontal post 214 of the hook 20, thus avoiding the using fatigue of the air stop sheet 7. A length of the vertical post 213 of the hook 20 matches with the output power of the air compressor to comply with amplitude of the air stop sheet 7. When the piston stops, the open angle θ and an air flowing space Z produces between the acting zone 73 of the air stop sheet 7 and the plane of the top of the head 21, wherein the passing orifice 731 of the air stop sheet 7 is stopped by the horizontal post 214 of the hook 20. The vertical post of the hook 20 is configured to turn on/off, expand, and retract the air stop sheet 7, so a length (or a height) of the vertical post 213 is determined based on the output power of the air compressor to match with a moving path of the air stop sheet 7, and the horizontal post 214 is configured to adjust a height of the air stop sheet 7.

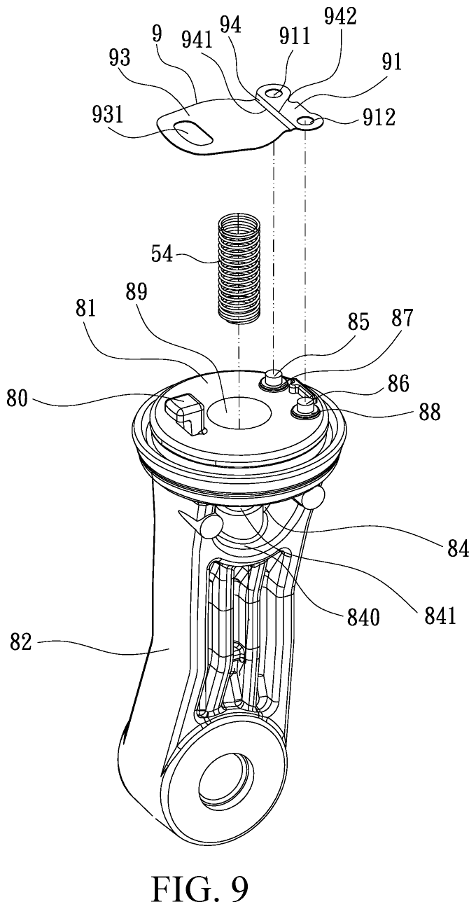

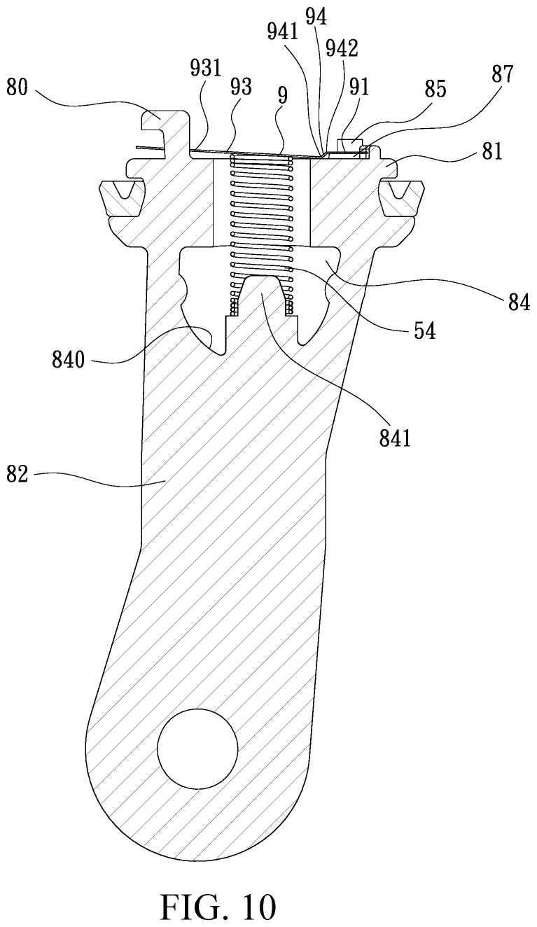

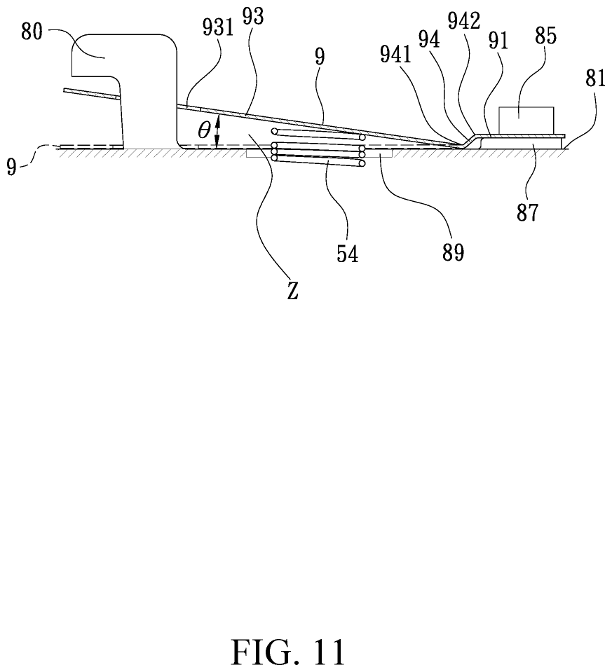

The air stop sheet 7 includes the bending section 71 on which the at least one collapsible guide line 711 are formed so that the open angle θ is defined between the acting zone 73 of the air stop sheet 7 and the plane of the top of the head 21. Preferably, a size and a hardness of the air stop sheet 7 are determined based on the output power of the air compressor. To comply with a large output power of the air compressor, an amplitude of the air stop sheet has to be increased by forming a bending section 94 on which a first collapsible guide line 941 and a second collapsible guide line 942 are formed. With reference to FIGS. 9-11, the air stop sheet 9 has a positioning zone 91, and the positioning zone 91 of the air stop sheet 9 has two spaced orifices 911, 912. The air stop sheet 9 further has an acting zone 93 opposite to the positioning zone 91 of the air stop sheet 9, wherein the acting zone 93 of the air stop sheet 9 has a passing orifice 931, the head 81 has a hook 80 configured to engage with the passing orifice 931, and the head 81 has a piston rod 82 extending downward from the head 81, the piston rod 82 has a cavity 840 defined on a top thereof, wherein the cavity 840 has an air conduit 84 formed therein, a column 841 extending from a bottom of the cavity 840, and a spring 54 fitted on the column 841, wherein when the piston moves in the upward moving stroke, the acting zone 93 of the air stop sheet 9 contacts with the plane of the top of the head 81 so that the air conduit 84 is closed by the air stop sheet 9. When the piston moves in the downward moving stroke, the air stop sheet 9 is pushed by external airs to expand but is limited by the hook 80, thus avoiding the using fatigue of the air stop sheet 9. The bending section 94 is defined between the positioning zone 91 and the acting zone 93, wherein the bending section 94 has the first collapsible guide line 941 and the second collapsible guide line 942 formed thereon, and the two spaced orifices 911, 912 of the positioning zone 91 pass through two separated extensions 85, 86 of a plane of a top of the head 81 and are stopped by two spaced circular shoulders 87, 88 of the plane of the top of the head 81, such that when the air compressor operates in the large output power, the first collapsible guide line 941 abuts against the plane of the top of the head 81, and an open angle θ produces between the acting zone 93 of the air stop sheet 9 and the plane of the top of the head 81. When the piston of the air compressor stops, the spring 54 urges the air stop sheet 9 to expand, and the acting zone 93 of the air stop sheet 9 is opened at the open angle θ by using the first collapsible guide line 941, and the acting zone 93 of the air stop sheet 9 keep turning on relative to the air channel 89 so that a pressure of the cylinder 13 balances with atmosphere, and the piston is not stopped by an additional resistance (i.e. a back-pressure resistance) in the upward moving stroke after the air compressor 10 is opened again, hence the piston moves in the cylinder 13 smoothly to enhance using safety and service life and to inflate the compressed airs into the deflated object easily. Preferably, the air stop sheet 9 has the bending section 94 to be turned on/off, expanded, and retracted smoothly, thus enhancing the service life.

While the preferred embodiments of the invention have been set forth for the purpose of disclosure, modifications of the disclosed embodiments of the invention and other embodiments thereof may occur to those skilled in the art. Accordingly, the appended claims are intended to cover all embodiments which do not depart from the spirit and scope of the invention.

What is claimed is:

1. An air compressor comprising a piston which is actuated by a motor to move upward and downward in a cylinder;
wherein the piston of the air compressor includes an air stop sheet mounted on a head thereof, and the air stop sheet has a bending section, wherein the bending section has a positioning zone arranged on the head, and the bending section further has an acting zone located opposite to the positioning zone and configured to cover an air channel of the piston;
wherein the bending section is a boundary axis of the acting area and the positioning zone of the air stop sheet so that a top of the air stop sheet facing the cylinder forms an obtuse angle less than 180 degrees, and a back surface of the acting zone of the air stop sheet backing a top of the cylinder turns on relative to a plane of a top of the head at an open angle θ, thus producing an air flowing space;
wherein a piston rod extends downward from the head, and the piston rod includes a cavity horizontally passing through a top of the piston rod and communicating with the air channel of the head, an air conduit formed in the cavity, wherein the cavity communicates with the air channel of the head, the cavity has a column extending from a bottom thereof, and a spring fitted on the column and inserting through the air channel of the head along the cavity of the piston rod so that the spring abuts against a back surface of an acting zone of an air stop sheet, wherein the air stop sheet is forced by the spring to locate in the acting zone at the open angle θ, and the air conduit and the air channel communicate with atmosphere.

2. The air compressor as claimed in claim 1, wherein at least one collapsible guide lines is formed on the bending section to match with an output power of the air compressor.

3. The air compressor as claimed in claim 2, wherein a collapsible guide lines is formed on the bending section.

4. The air compressor as claimed in claim 1, wherein the head has the two separated bolts, and the positioning zone of the air stop sheet has two spaced orifices connecting with the two separated bolts of the head; the acting zone of the air stop sheet has a passing orifice, and the head has a hook configured to engage with the passing orifice, wherein when the piston of the air compressor stops, the acting zone opens the air channel of the head of the piston.

5. The air compressor as claimed in claim 4, wherein the hook of the head has a vertical post and a horizontal post, wherein a length/a height of the vertical post is determined based on an output power of the air compressor to match with a moving path of the air stop sheet, and the horizontal post is configured to adjust a height of the air stop sheet.

6. The air compressor as claimed in claim 2, wherein the bending section includes a first collapsible guide line and a second collapsible guide line formed thereon, when the air compressor stops, the acting zone of the air stop sheet turns on relative to the plane of the top of the top support plate, and a passing orifice of the air stop sheet is stopped by of the hook.

7. The air compressor as claimed in claim 6, wherein the two spaced orifices of the positioning zone pass through two separated extensions of a plane of a top of the head and are stopped by two spaced circular shoulders of the head.
